(19) United States
(12) Patent Application Publication
(10) Pub. No.: US 2016/0012650 A1
(43) Pub. Date: Jan. 14, 2016

(54) Marine Data Collection

(71) Applicant: Navico Holding AS, Egersund (NO)

(72) Inventors: Shane Coloney, Jenks, OK (US); Tom Isaacson, Auckland (NZ); Phillip King Gaynor, Pocasset, MA (US)

(21) Appl. No.: 14/673,790

(22) Filed: Mar. 30, 2015

Related U.S. Application Data
(60) Provisional application No. 62/040,767, filed on Aug. 22, 2014.
(60) Provisional application No. 62/022,064, filed on Jul. 8, 2014.

(51) Int. Cl. G07C 5/00

(52) U.S. Cl. CPC G07C 5/008

(57) ABSTRACT

Various implementations described herein are directed to a non-transitory computer readable medium having stored thereon computer-executable instructions which, when executed by a computer, may cause the computer to receive telematics data collected by a plurality of marine electronics devices. The telematics data is transmitted by one or more peripheral devices connected to the marine electronics devices. The computer may filter the telematics data based on a type of information or a type of peripheral device. The computer may also transmit the filtered data to a third party. The third party is selected based at least in part on the type of information or type of peripheral device.

### CROSS-REFERENCE TO RELATED APPLICATIONS

This application claims the benefit of U.S. Provisional Patent Application Ser. No. 62/022,064, filed Jul. 8, 2014, titled VARIOUS SOFTWARE FEATURES FOR MARINE ELECTRONICS DEVICE, and the disclosure of which is incorporated herein by reference.

This application claims the benefit of U.S. Provisional Patent Application Ser. No. 62/040,767, filed Aug. 22, 2014, titled VARIOUS SOFTWARE FEATURES FOR MARINE ELECTRONICS DEVICE, and the disclosure of which is also incorporated herein by reference

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Various forms of marine electronics data may be processed or displayed using a computing device disposed aboard a vessel. In one scenario, the computing device may include a multi-function display (MFD). Marine electronics data displayed using the computing device may be used to help navigate the vessel, and the data may include, for example, sonar data, chart data, radar data, or navigation data such as laylines.

### SUMMARY

Described herein are implementations of various technologies for a non-transitory computer-readable medium having stored thereon computer-executable instructions which, when executed by a computer, cause the computer to perform various actions. The actions may include receiving telematics data collected by a plurality of marine electronics devices. The telematics data is transmitted by one or more peripheral devices connected to the marine electronics devices. The actions may include filtering the telematics data based on a type of information or a type of peripheral device. The actions may also include transmitting the filtered data to a third party. The third party is selected based at least in part on the type of information or type of peripheral device.

Described herein are also implementations of various technologies for a non-transitory computer-readable medium having stored thereon computer-executable instructions which, when executed by a computer, cause the computer to perform various actions. The actions may include receiving data collected by a marine electronics device or a peripheral device connected to the marine electronics device. The actions may include associating the data with a user account. The actions may include retrieving user information for a social networking service. The user information is associated with the user account. The actions may also include transmitting at least a portion of the associated data and the user information to the social networking service.

Described herein are also implementations of various technologies for a non-transitory computer-readable medium having stored thereon computer-executable instructions which, when executed by a computer, cause the computer to perform various actions. The actions may include receiving data collected by a plurality of marine electronics devices. The actions may include associating the data with a user account, a marine electronics device, or a peripheral device connected to a marine electronics device. The actions may also include sorting the received data into one or more categories. The categories are selected from a group consisting of telematics data, user interface history, web browser history, software application crash history, navigational data, sonar data, radar data, water temperature data, air temperature data, marine vessel location data, or marine vessel accident data.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a marine networking system in accordance with implementations of various techniques described herein.

FIG. 2 is a flow diagram of a method for uploading stored data to a cloud server in accordance with implementations of various techniques described herein.

FIG. 3 is a flow diagram of a method for aggregating and sharing data from a plurality of marine electronics devices in accordance with implementations of various techniques described herein.

FIG. 4 illustrates a schematic of a marine electronics device in accordance with implementations of various techniques described herein.

FIG. 5 illustrates a schematic diagram of a computing system in which the various technologies described herein may be incorporated and practiced.

### DETAILED DESCRIPTION

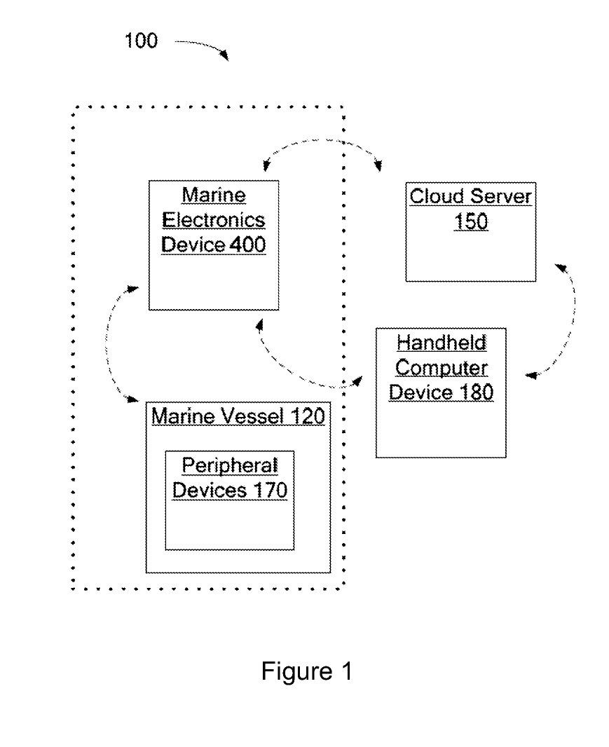

Various implementations described herein will now be described in more detail with reference to FIGS. 1-5

FIG. 1 illustrates a block diagram of a marine networking system 100 in accordance with implementations of various techniques described herein. The marine networking system 100 may include several components, such as a marine electronics device 400 (which may be a multi-function display or a chartplotter), a cloud server 150, a marine vessel 120, and peripheral devices 170 disposed on the marine vessel 120. The cloud server 150 may be a server connected to the Internet. A web browser may be included in the user interface of the marine electronics device 400. In one implementation, a user may use the web browser to connect to the cloud server 150 over the Internet. The marine electronics device 400 may collect data from the marine networking system 100. The marine electronics device 400 may also manage and control various navigation related systems or peripheral devices 170 disposed onboard the marine vessel 120.

The peripheral devices 170 may include a sonar system, a Global Positioning System (GPS) device, such as a GPS receiver or a similar device such as GLONASS or global navigation satellite system (GNSS) receiver, a radar system, a sonar system, a propulsion system, various navigation systems, lighting systems, wireless data communication devices, wireless audio communications devices, audio and video entertainment devices, weather and environmental sensor systems, or any other electronic systems disposed on the marine vessel 120. The marine electronics device 400 may be connected to the peripheral devices 170 by a wired or wireless connection, or over a bus. In one implementation, the marine electronics device 400 may communicate with the peripheral devices 170 using a National Marine Electronics Association (NMEA) communication standard (e.g., NMEA 2000 or NMEA 0183) or a compatible protocol, including a proprietary compatible protocol. In another implementation, the marine electronics device 400 may communicate with the peripheral device 170 using a Society of Automotive Engineers (SAE) J1939 communication standard or a compatible protocol, including a proprietary compatible protocol. The peripheral devices 170 may also be configured to receive data from the cloud server 150. For more information regarding the marine electronics device 400, see the section titled MARINE ELECTRONICS DEVICE below.

The marine electronics device 400 or the peripheral devices 170 may be associated with a user or user account. As such, a user may set up a user account with the cloud server 150. The user may register the marine electronics device 400, the marine vessel 120, or the peripheral devices 170 to the user account. The user account may be associated with security information (e.g., an account identification, an account password, etc.), a personal profile (e.g., customer identification, such as name, address, phone number, etc.), product information (e.g., product serial numbers, the type of marine electronics device 400, the type of the marine vessel 120, and other component information such as for a radar system or sonar system, etc.), and financial information (e.g., customer billing information, credit card information, purchase history, etc.). The security information or other account information may be stored on the cloud server 150. The user may access and modify information associated with the user's account to verify accuracy. The cloud server 150 and marine electronics device 400 may use security measures to maintain the privacy of users and to protect personally identifiable information or other information.

The user account may be associated with an online profile, such as a profile that is visible to other users on a social networking site. Information in the user account may be synchronized or shared with information displayed in the online profile. The online profile may also be used to display information collected by the marine electronics device 400 or from the peripheral devices 170. As such, the marine electronics device 400 may allow a user to manage information in the online profile by changing various settings or information stored in the user account. For example, a user may use a marine electronics device 400 to alter privacy settings regarding which users, such as social media friends, are able to access the user's online profile, or information settings regarding what information is collected or displayed with respect to the user. The online profile may also be synchronized with one or more respective social networking sites. For example, a change to information in the online profile may automatically cause a corresponding change in the information displayed in the respective social networking sites.

Collecting and Uploading Data from a Marine Electronics Device to a Cloud Server

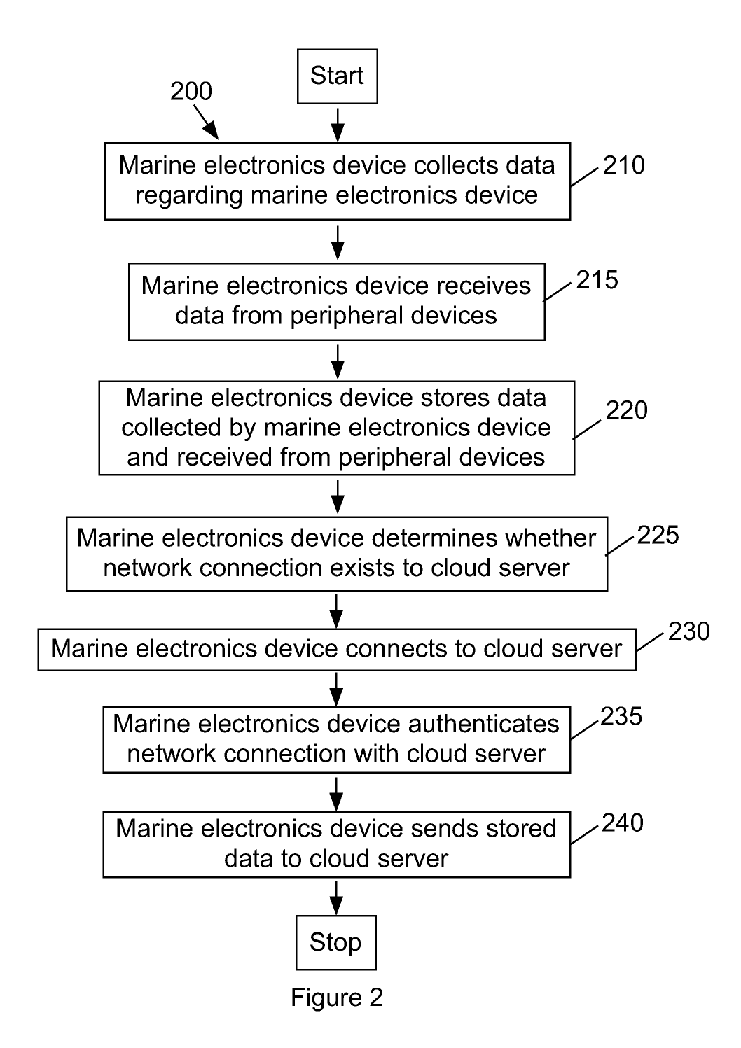

FIG. 2 illustrates a flow diagram for a method 200 for uploading stored data to the cloud server 150 in accordance with implementations of various techniques described herein. In one implementation, method 200 may be performed by any computer system 500, including a marine electronics device 400 and the like. It should be understood that while method 200 indicates a particular order of execution of operations, in some implementations, certain portions of the operations might be executed in a different order, or on different systems. Further, in some implementations, additional operations or steps may be added to the method 200. Likewise, some operations or steps may be omitted.

At block 210, the marine electronics device 400 may collect data regarding the marine electronics device 400. The collected data may describe which devices are or were connected to the marine electronics device 400, how the marine electronics device 400 was used, any problems a user experienced, system performance history regarding one or more software or hardware components, a crash history regarding one or more software applications operating on the marine electronics device 400, a user interface history, a record of how often a user changes pages, a record describing which user interface setup is preferred or most commonly used, a web browser history, how often particular software features are selected by a user, or other data relating to the operation of the marine electronics device 400. In one implementation, a software application operating in the background of the marine electronics device 400 may perform block 210 automatically. For example, the background software application may be running without being displayed on a user interface.

The collected data may describe one or more user activities monitored by the marine electronics device 400, such as data relating to fishing logs, trip logs, tournament or races and other activities engaged in by a user of the marine electronics device 400. Fishing logs may comprise data regarding a catch, such as the location of a catch, the time of the catch, the size of the fish caught, or the type of fish caught. Trip logs may comprise data regarding the starting time and ending time of a trip, locations visited on the trip, or navigation conditions during the trip. With respect to tournament or races, the marine electronics device 400 may collect data regarding one or more races, such as how many participants competed in the race, how the user finished in the race, position in the race, or a user's ranking in a tournament with multiple races.

At block 215, the marine electronics device 400 may receive data from the peripheral devices 170. The data from the peripheral devices 170 may include telematics data, which is data transmitted over the marine networking system 100. The telematics data may include network information obtained from any device or system capable of being measured or controlled through electronic means, such as analog or digital methods. The devices or systems may include switch position and switch activation systems, electric power generation and supply systems, such as AC and DC electrical systems, water management systems, lighting systems, and security systems. The telematics data may also describe whether any errors, faults, or problems have occurred in these and other systems such as the sonar system, radar system, and other peripheral devices 170. The telematics data may also describe the GPS location of the vessel 120 when an error, fault, or problem occurred.

The telematics data may include information regarding measurements from sensors in an engine on the vessel 120. The engine sensors may record engine operating conditions. For example, the engine sensors may record data describing the engine's performance, how long the engine has been operating, information on engine alarms, or the results of engine diagnostic tests.

The telematics data may also include data associated with an NMEA communication standard. The NMEA communication standard may provide a protocol for transmitting and receiving data acquired by sensors and marine instruments. Examples of devices that may communicate using an NMEA communication standard include auto pilots, wind instruments, water temperature gauges, depth sounders, vessel control devices, and engine instruments.

The telematics data may include data regarding navigational and environmental conditions around the marine vessel 120. The marine electronics device 400 may receive the navigation and environmental data from instruments disposed on the marine vessel 120. For example, the marine electronics device 400 may receive air temperature data, water temperature data, weather information, wind data, heading data, bearing data, location data, sonar data, radar data, engine and propulsion data, vessel control data, or any other navigational or environmental data.

At block 220, the marine electronics device may store the data collected by the marine electronics device at block 210 or the data received from the peripheral devices 170 at block 215. The marine electronics device 400 may store the data in memory or a hard disk on the marine electronics device 400, or to an external storage device. In one implementation, the data may be stored in a database on the marine electronics device 400.

At block 225, the marine electronics device 400 may determine whether a network connection exists between the marine electronics device 400 and the cloud server 150. For instance, method 200 may determine whether the marine electronics device 400 has Internet access through a wireless connection or a wired connection, e.g., through an Ethernet connection. For a wireless connection, the marine electronics device 400 may search for a wireless access point, such as a nearby router, WiFi hotspot or cellular tower, which may be broadcasting proximate the marine electronics device 400.

If no connection to the cloud server 150 is found, the marine electronics device 400 may attempt to establish a connection or repeatedly perform a check for a network connection after a preset amount of time. If a network connection exists, method 200 may proceed to block 230. If the network connection does not exist, the method may remain at block 225 until a connection is established. For example, the method 200 may store data at block 220 while the marine electronics device 400 is on a vessel, and continue to block 230 after the marine electronics device 400 has been removed from the vessel 120 and connected to a network.

At block 230, the marine electronics device 400 may connect to the cloud server 150 over the network connection.

At block 235, the marine electronics device 400 may authenticate the network connection from block 230 with the cloud server 150 (also referred to as a “handshake”). To authenticate the network connection, the marine electronics device 400 may send security information (e.g., password information) to the cloud server 150 to verify that the marine electronics device 400 is associated with a particular user or user account. The security information may correspond to information stored in a designated user account on the cloud server 150.

If the cloud server 150 verifies that the security information matches a designated user account, the cloud server 150 may create a secure connection with the marine electronics device 400. The secure connection may encrypt information that is sent between the cloud server 150 and the marine electronics device 400.

At block 240, the marine electronics device 400 may send or upload the stored data from block 220 to the cloud server 150 over the network connection. After uploading the data, the marine electronics device 400 may delete the data stored locally on the marine electronics device 400. The stored data may be sent automatically upon connecting to the cloud server 150 at block 230 or after authenticating a network connection at block 235. In one implementation, the marine electronics device 400 may store data at block 220 while the marine electronics device 400 lacks Internet access. In this implementation, once a network connection to the cloud server 150 is established, the marine electronics device 400 may upload the stored data to the cloud server 150.

The marine electronics device 400 may send the stored data at a predetermined time designated for uploading data to the cloud server 150. For example, the stored data may be transmitted to the cloud server 150 once per day. Alternatively, a user may manually authorize a data offload to the cloud server 150. For example, a user may select an icon in the user interface of the marine electronics device 400 to initiate a data transmission to the cloud server 150.

In one implementation, a user may grant permission to the marine electronics device 400 allowing the device to perform the data collection procedures described at blocks 210-240. In granting permission, the user may choose which types of data are stored by the marine electronics device 400 or sent to the cloud server 150. For example, a dialog box on the marine electronics device 400 may provide notice to the user that personal or other types of data may be collected by the marine electronics device 400. In this example, the dialog box may then allow the user to enable or disable the collection of one or more types of data. The dialog box may include a description of how the stored data may be used or information regarding various privacy policies. In another implementation, the user may take an affirmative action to opt-out or prevent various data collection procedures at blocks 210-240. For example, after reviewing a description of the data collection procedures of blocks 210-240, the user may disable the data collection features.

The marine electronics device 400 may provide notifications asking a user how to use the stored data. For instance, when a program on the marine electronics device 400 crashes, a message may be displayed to the user asking for permission to send data related to the crash to the cloud server 150. The notifications may be enabled or disabled in user preferences on the marine electronics device 400 or in a user account.

Aggregating Data from a Plurality of Marine Electronics Devices

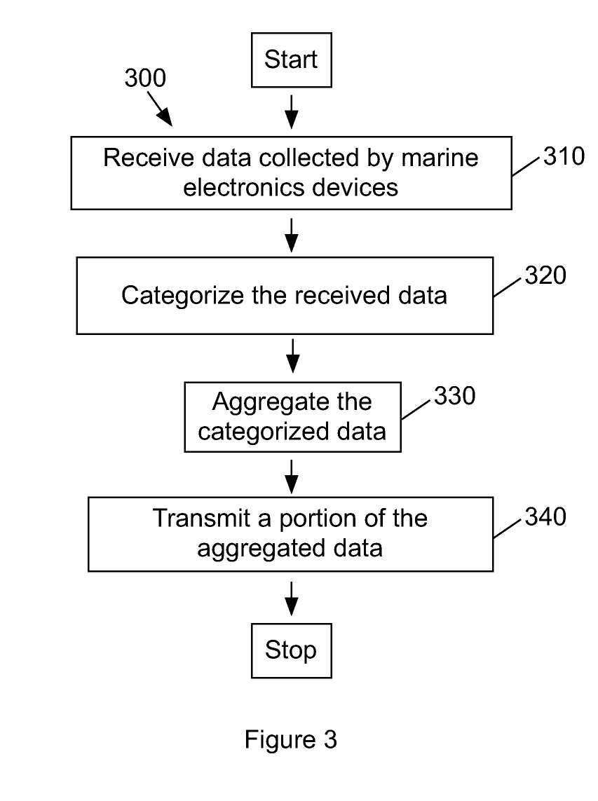

FIG. 3 is a flow diagram of a method 300 for aggregating and sharing data from a plurality of marine electronics devices in accordance with implementations of various techniques described herein. In one implementation, method 300 may be performed by the cloud server 150. It should be understood that while method 300 indicates a particular order of execution of operations, in some implementations, certain portions of the operations might be executed in a different order. Further, in some implementations, additional operations or steps may be added to the method 300. Likewise, some operations or steps may be omitted.

At block 310, the cloud server 150 may receive data collected by a plurality of marine electronics devices (i.e., “the collected information”), which may be dispersed at various geographical locations. The collected information may be similar to the data collected and received by the marine electronics device 400 and sent to the cloud server 150 in method 200. The collected information may describe operations of the marine electronics devices 400 or peripheral devices 170 connected to the marine electronics devices 400. For example, the collected information may be telematics data transmitted by the peripheral devices 170 or marine electronics devices 400 over an NMEA bus.

In one implementation, the cloud server 150 may receive information collected by one or more handheld computer devices 180 in addition to or in lieu of one or more of the plurality of marine electronics devices 400. The handheld computer devices 180 may connect to the cloud server 150 over network connections similar to the network connection described at blocks 225-230 above. The network connections may be authenticated in a similar manner as the authentication described at block 235.

At block 320, the cloud server 150 may categorize, or filter, the collected information according to one or more predetermined types of information. For instance, the collected information may be categorized as telematics data, user interface history, web browser history, crash history regarding one or more software applications, navigational data, sonar data, radar data, water temperature data, air temperature data, location data regarding one or more marine vessels, accident data regarding one or more marine vessels or other detected hazards that are above, below, or on the water.

In one implementation, the collected information may be associated or linked with a corresponding user, the marine vessel 120, the handheld computer device 180, or the marine electronics device 400 that sent the data to the cloud server 150. The cloud server 150 may then analyze the collected information with respect to the particular user, marine vessel, handheld computer device or marine electronics device.

At block 330, the cloud server 150 may aggregate the data from blocks 310 or 320 into one or more databases. For instance, data from the plurality of marine electronics devices may be combined and stored into a database on the cloud server 150. The data may be organized in the database based on the associations described at block 320. In some implementations, data received from handheld computer devices may be included in the aggregated data with the data from the marine electronics devices. In one implementation, the aggregated data may correspond to various data acquired during a plurality of trips from different marine vessels and/or users.

The cloud server 150 may determine one or more data characteristics based on the aggregated data. For instance, the aggregated data may be used to map or analyze an overlapping region of interest (e.g., provide information about the waterways around an island obtained from the plurality of marine electronics devices). As such, the cloud server 150 may generate a sonar map, a radar map, or other marine electronic data representation for the overlapping region of interest. In another implementation, the data characteristics may include physical attributes of the navigation route such as water depth, temperature, description of currents, the types of fish caught along the navigation route, and other physical features. In other implementations, the data characteristics may include statistics regarding various users or how they have used their devices. For instance, the cloud server 150 may determine the failure rate of a particular type of device, such as a type of sonar system, based on the aggregated data.

At block 340, the cloud server 150 may send at least a portion of the aggregated data to one or more predetermined recipients. The data may be transmitted to the recipient through social networking sites, which is described below. Predetermined recipients may also include various parties such as insurance carriers, financing companies, government agencies, non-profits, advertisers/publishers, retailers/e-commerce, boat builders, engine and other boat sub-system manufacturers, boating/fishing gear suppliers, dealers, service providers or any other organization. As such, the cloud server 150 may designate certain types of data for transmission to one or more remote servers that correspond to a particular predetermined recipient. For example, an autopilot data filter may be applied to the received data at block 320 to remove data that does not correspond to an autopilot, and the filtered data may then be transmitted to an autopilot manufacturer. In one implementation, a portion of the aggregated data regarding accidents experienced by the marine vessel 120 or a particular user may be sent to an insurance carrier to determine insurance rates for the marine vessel 120.

The predetermined recipients may include one or more social networking sites. For instance, a portion of the aggregated data may be displayed on a website, e.g. a personal profile on a particular social networking site. Examples of social networking sites may include sites such as Facebook™, LinkedIn™ or Twitter™. Collected information may be posted automatically by the cloud server 150 or marine electronics device 400 to a user's online profile at a social networking site. For instance, when a respective user completes a race, the cloud server 150 may receive the user's results in the race from the marine electronics device 400, and the cloud server 150 may automatically post the user's results to the respective user's profile at a particular social networking site, e.g., a notification may be posted that he or she placed second in the race. In other implementations, a social networking site may use the aggregated data obtained from a plurality of users for a variety of purposes, e.g., a notification may be posted that shows the results of all users that participated in the race.

The cloud server 150 may use the aggregated data to monitor the performance of the marine electronics device 500, the peripheral devices 170 or the marine vessel 120. As such, the cloud server 150 may use the aggregated data to track changes over a predetermined period of time regarding operating conditions or performance levels (e.g., has the user interface on the marine electronics device 400 or the peripheral devices 170 decreased in performance speed, is the propulsion system operating at industry standards, etc.). For example, a portion of the aggregated data regarding a type of propulsion system on various marine vessels may be sent to dealers and/or service providers for determining future maintenance for the marine vessel 120.

In one implementation, the cloud server 150 may send product recommendations to particular users based on the aggregated data. For instance, the cloud server 150 may analyze which products are used by similar users and make recommendations to a particular user accordingly.

Portions of method 300 may be performed in response to receiving a request for data from a third party corresponding to a piece of equipment, type of equipment, vessel, or vessel type. For example, an engine manufacturer may request data relating to a selected engine type, and blocks 320-40 may then be performed to aggregate and transmit data relating to the selected engine type to the engine manufacturer. In another example, a boatbuilder may request data for all vessels of a selected type, and data relating to the selected type of vessel may be transmitted to the boatbuilder. In yet another example, a repairer may request data corresponding to a specific vessel that they are performing maintenance work on, and data corresponding to that vessel may be transmitted to the repairer. In one implementation, the request for data from the third party may be performed using an Application Program Interface (API).

### Marine Electronics Device

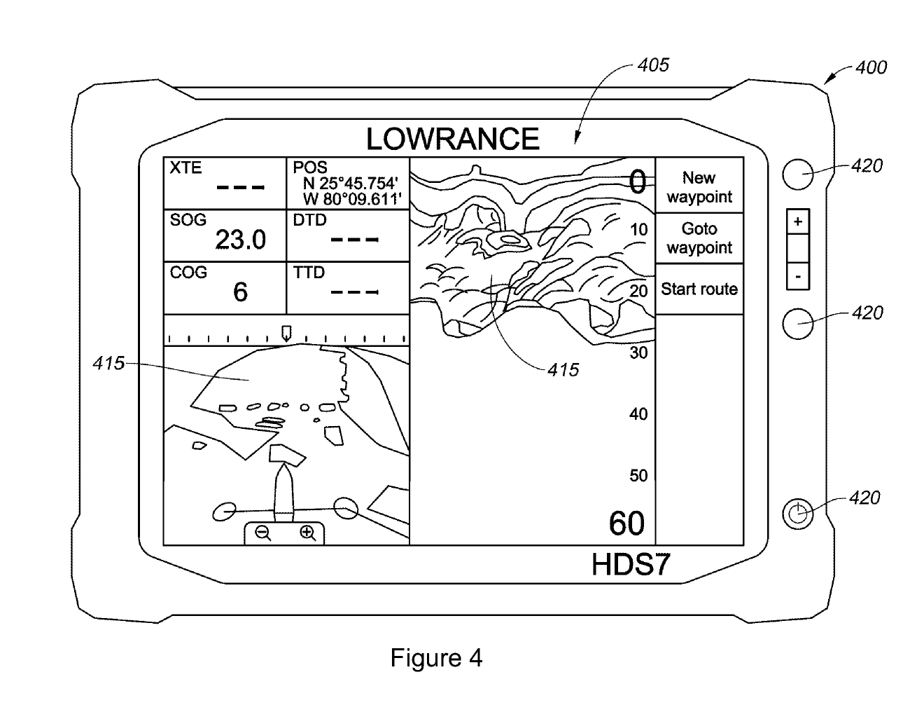

FIG. 4 illustrates a schematic diagram of a marine electronics device 400 in accordance with various implementations described herein. The marine electronics device 400 includes a screen 405. In certain implementations, the screen 405 may be sensitive to touching by a finger. In other implementations, the screen 405 may be sensitive to the body heat from the finger, a stylus, or responsive to a mouse. The marine electronics device 400 may be attached to an NMEA bus or network. The marine electronics device 400 may send or receive data to or from another device attached to the NMEA bus. For example, the marine electronics device 400 may transmit commands and receive data from a motor or a sensor using an NMEA 2000 bus. The marine electronics device 400 may transmit or receive NMEA 2000 or 0183 compliant messages, messages in a proprietary format that do not interfere with NMEA 2000 or 0183 compliant messages or devices, or messages in any other format. The device 400 may display marine electronic data 415. The marine electronic data types 415 may include chart data, radar data, sonar data, steering data, dashboard data, navigation data, fishing data, and the like. The marine electronics device 400 may also include a plurality of buttons 420, which may be either physical buttons or virtual buttons, or a combination thereof. The marine electronics device 400 may receive input through a screen 405 sensitive to touch or buttons 420.

### Computing System

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may be implemented in the context of marine electronics, such as devices found in marine vessels and/or navigation systems. Ship instruments and equipment may be connected to the computing systems described herein for executing one or more navigation technologies. As such, the computing systems may be configured to operate using sonar, radar, GPS and like technologies.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

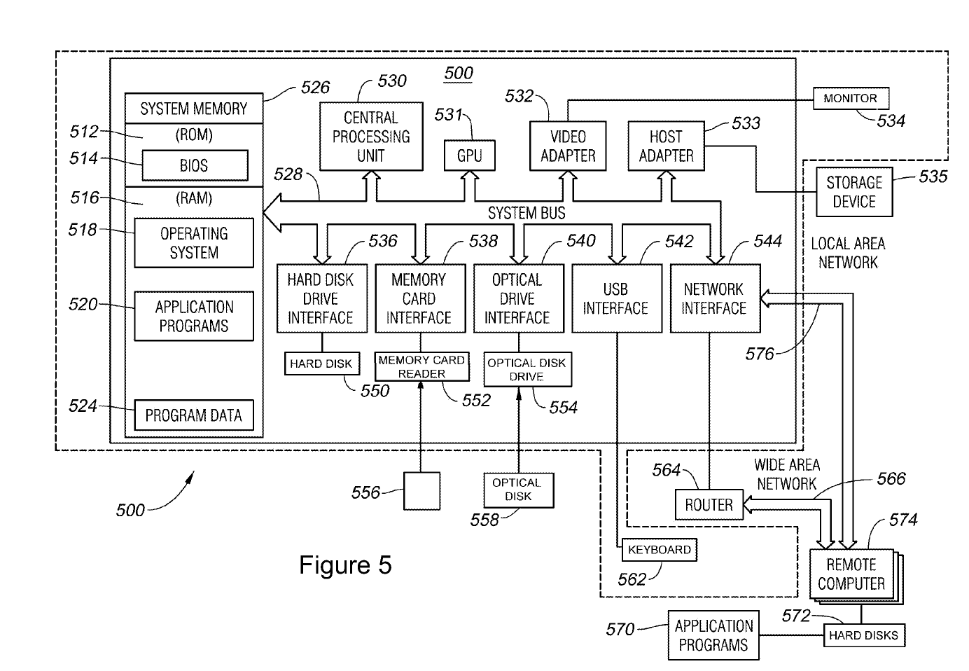

FIG. 5 illustrates a computer system 500 into which implementations of various technologies and techniques described herein may be implemented. Computing system 500 may be a conventional desktop, a handheld device, a wearable device, a controller, a personal digital assistant, a server computer, an electronic device/instrument, a laptop, a tablet, or part of a navigation system, marine electronics, or sonar system. It should be noted, however, that other computer system configurations may be used.

The computing system 500 may include a central processing unit (CPU) 530, a system memory 526 and a system bus 528 that couples various system components including the system memory 526 to the CPU 530. Although only one CPU 530 is illustrated in FIG. 5, it should be understood that in some implementations the computing system 500 may include more than one CPU 530.

The CPU 530 can include a microprocessor, a microcontroller, a processor, a programmable integrated circuit, or a combination thereof. The CPU 530 can comprise an off-the-shelf processor such as a Reduced Instruction Set Computer (RISC), including an Advanced RISC Machine (ARM) processor, or a Microprocessor without Interlocked Pipeline Stages (MIPS) processor, or a combination thereof. The CPU 530 may also include a proprietary processor. The CPU may include a multi-core processor.

The CPU 530 may provide output data to a Graphics Processing Unit (GPU) 531. The GPU 531 may generate graphical user interfaces that present the output data. The GPU 531 may also provide objects, such as menus, in the graphical user interface. A user may provide inputs by interacting with the objects. The GPU 531 may receive the inputs from interaction with the objects and provide the inputs to the CPU 530. In one implementation, the CPU 530 may perform the tasks of the GPU 531. A video adapter 532 may be provided to convert graphical data into signals for a monitor 534, which may also be referred to as a screen. The monitor 534 can be sensitive to heat or touching (now collectively referred to as a “touch screen”). In one implementation, the computer system 500 may not include a monitor 534.

The GPU 531 may be a microprocessor specifically designed to manipulate and implement computer graphics. The CPU 530 may offload work to the GPU 531. The GPU 531 may have its own graphics memory, and/or may have access to a portion of the system memory 526. As with the CPU 530, the GPU 531 may include one or more processing units, and each processing unit may include one or more cores.

The system bus 528 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 526 may include a read only memory (ROM) 512 and a random access memory (RAM) 516. A basic input/output system (BIOS) 514, containing the basic routines that help transfer information between elements within the computing system 500, such as during start-up, may be stored in the ROM 512. The computing system may be implemented using a printed circuit board containing various components including processing units, data storage memory, and connectors.

Certain implementations may be configured to be connected to a GPS and/or a sonar system. The GPS and/or sonar system may be connected via the network interface 544 or Universal Serial Bus (USB) interface 542. In one implementation, the computing system 500, the monitor 534, the screen 505 and buttons may be integrated into a console.

The computing system 500 may further include a hard disk drive 536 for reading from and writing to a hard disk 550, a memory card reader 552 for reading from and writing to a removable memory card 556 and an optical disk drive 554 for reading from and writing to a removable optical disk 558, such as a CD ROM, DVD ROM or other optical media. The hard disk drive 550, the memory card reader 552 and the optical disk drive 554 may be connected to the system bus 528 by a hard disk drive interface 536, a memory card interface 538 and an optical drive interface 540, respectively. The drives and their associated computer-readable media may provide nonvolatile storage of computer-readable instructions, data structures, program modules and other data for the computing system 500.

Although the computing system 500 is described herein as having a hard disk 550, a removable memory card 556 and a removable optical disk 558, it should be appreciated by those skilled in the art that the computing system 500 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, including a Solid State Disk (SSD), CD-ROM, digital versatile disks (DVD), or other optical storage, magnetic cassettes, magnetic tape, magnetic disk storage or other magnetic storage devices, or any other medium which can be used to store the desired information and which can be accessed by the computing system 500. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. The computing system 500 may also include a host adapter 533 that connects to a storage device 535 via a small computer system interface (SCSI) bus, a Fiber Channel bus, an eSATA bus, or using any other applicable computer bus interface. The computing system 500 can also be connected to a router 564 to establish a wide area network (WAN) 566 with one or more remote computers. The router 564 may be connected to the system bus 528 via a network interface 544. The remote computers 574 can also include hard disks 572 that store application programs 570.

In another implementation, the computing system 500 may also connect to one or more remote computers 574 via local area network (LAN) 576 or the WAN 566. When using a LAN networking environment, the computing system 500 may be connected to the LAN 576 through the network interface or adapter 544. The LAN 576 may be implemented via a wired connection or a wireless connection. The LAN 576 may be implemented using Wi-Fi technology, cellular technology, or any other implementation known to those skilled in the art. The network interface 544 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 574. It will be appreciated that the network connections shown are exemplary and other means of establishing a communications link between the computer systems may be used. The network interface 544 may also include digital cellular networks, Bluetooth, or any other wireless network interface.

A number of program modules may be stored on the hard disk 550, memory card 556, optical disk 558, ROM 512 or RAM 516, including an operating system 518, one or more application programs 520, program data 524 and a database system. The one or more application programs 520 may contain program instructions configured to perform methods 200 or 300 according to various implementations described herein. The operating system 518 may be any suitable operating system that may control the operation of a networked personal or server computer, such as Windows® XP, Mac OS® X, Unix-variants (e.g., Linux® and BSD®), Android®, iOS®, and the like.

A user may enter commands and information into the computing system 500 through input devices such as a keyboard 562 and pointing device. Other input devices may include a microphone, joystick, game pad, satellite dish, scanner, user input button, wearable device, or the like. These and other input devices may be connected to the CPU 530 through a USB interface 542 coupled to system bus 528, but may be connected by other interfaces, such as a parallel port, Bluetooth or a game port. A monitor 505 or other type of display device may also be connected to system bus 528 via an interface, such as a video adapter 532. In addition to the monitor 534, the computing system 500 may further include other peripheral output devices such as speakers and printers.

It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. Nothing in this application is considered critical or essential to the claimed invention unless explicitly indicated as being “critical” or “essential.”

Reference has been made in detail to various implementations, examples of which are illustrated in the accompanying drawings and figures. In the detailed description, numerous specific details are set forth in order to provide a thorough understanding of the present disclosure. However, it should be apparent to one of ordinary skill in the art that the present disclosure may be practiced without these specific details. In other instances, well-known methods, procedures, components, circuits and networks have not been described in detail so as not to unnecessarily obscure aspects of the implementations.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It should also be understood that the term “and/or” as used herein refers to and encompasses any and all possible combinations of one or more of the associated listed items. It should be further understood that the terms “includes,” “including,” “comprises” and/or “comprising,” when used in this specification, specify the presence of stated features, integers, steps, operations, elements, and/or components, but should not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

“Alternatively” should not be construed to only pertain to situations where the number of choices involved is exactly two, but rather refers to another possibility among many other possibilities.

Additionally, various technologies and techniques described herein include receiving user requests for a number of different operations. In certain instances, the user request for a particular operation will be explicitly described. It should be understood that a “request” or “can request” can also include, but are not limited to, touching a screen, double tapping a screen (tapping the screen twice in rapid succession), pressing a particular physical or virtual button, making a selection from a menu, swiping the screen (placing a finger towards an edge of the screen and traversing the screen while maintaining contact between the finger and the screen) placement of a cursor at a particular location, stylus pointing, mouse selection, an audible command, as well as the explicit description of the “request” for the particular operations.

While the foregoing is directed to implementations of various techniques described herein, other and further implementations may be devised without departing from the basic scope thereof, which may be determined by the claims that follow.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon a plurality of computer-executable instructions which, when executed by a computer, cause the computer to:
receive telematics data collected by a plurality of marine electronics devices, wherein the telematics data is transmitted by one or more peripheral devices connected to the marine electronics devices;
filter the telematics data based on a type of information or a type of peripheral device; and
transmit the filtered data to a third party, wherein the third party is selected based at least in part on the type of information or type of peripheral device.

2. The non-transitory computer-readable medium of claim 1, wherein the peripheral devices are sensors or marine instruments onboard a marine vessel.

3. The non-transitory computer-readable medium of claim 1, wherein the peripheral devices are connected to the marine electronics devices on a National Marine Electronics Association (NMEA) bus.

4. The non-transitory computer-readable medium of claim 1, wherein the peripheral devices comprise:
a radar system;
a sonar system;
a propulsion system;
a global positioning system (GPS) device;
an auto pilot;
a wind instrument;
a water temperature gauge;
a depth sounder;
an engine instrument;
vessel control devices; or
a combination thereof.

5. The non-transitory computer-readable medium of claim 1, wherein the telematics data comprises:
navigational data;
sonar data;
radar data;
water temperature data;
air temperature data;
location data regarding one or more marine vessels;
accident data regarding the one or more marine vessels;
engine and propulsion data;
vessel control data;
or a combination thereof.

6. The non-transitory computer-readable medium of claim 1, wherein the telematics data is in a National Marine Electronics Association (NMEA) 2000 or Society of Automotive Engineers (SAE) J1939 format.

7. The non-transitory computer-readable medium of claim 1, wherein the third party comprises:
one or more boat manufacturers;
one or more engine manufacturers;
one or more boating or fishing gear suppliers;
one or more insurance companies;
one or more finance companies
one or more service or maintenance product providers; or
a combination thereof.

8. A non-transitory computer-readable medium having stored thereon a plurality of computer-executable instructions which, when executed by a computer, cause the computer to:
receive data collected by a marine electronics device or a peripheral device connected to the marine electronics device;
associate the data with a user account;
retrieve user information for a social networking service, wherein the user information is associated with the user account; and
transmit at least a portion of the associated data and the user information to the social networking service.

9. The non-transitory computer-readable medium of claim 8, wherein the data transmitted to the social networking service describes a result of a race or competition.

10. The non-transitory computer-readable medium of claim 8, wherein the received data comprises:
navigational data;
sonar data;
radar data;
water temperature data;
air temperature data;
location data regarding one or more marine vessels;
accident data regarding the one or more marine vessels;
or a combination thereof.

11. The non-transitory computer-readable medium of claim 8, wherein the peripheral device is a sensor or marine instrument onboard a marine vessel.

12. The non-transitory computer-readable medium of claim 8, wherein the peripheral device is a National Marine Electronics Association (NMEA) compliant device.

13. The non-transitory computer-readable medium of claim 8, wherein the peripheral device comprises:
a radar system;
a sonar system;
a propulsion system;
a global positioning system (GPS) device;
an auto pilot;
a wind instrument;
a water temperature gauge;
a depth sounder;
an engine instrument;
an engine instrument;
vessel control devices; or
a combination thereof.

14. A non-transitory computer-readable medium having stored thereon a plurality of computer-executable instructions which, when executed by a computer, cause the computer to:
receive data collected by a plurality of marine electronics devices;
associate the data with a user account, a marine electronics device, or a peripheral device connected to a marine electronics device; and
sort the received data into one or more categories, wherein the categories are selected from a group consisting of telematics data, user interface history, web browser history, software application crash history, navigational data, sonar data, radar data, water temperature data, air temperature data, marine vessel location data, or marine vessel accident data.

15. The non-transitory computer-readable medium of claim 14, wherein the data comprises:
navigational data;
sonar data;
radar data;
water temperature data;
air temperature data;
location data regarding one or more marine vessels;
accident data regarding the one or more marine vessels;
or a combination thereof.

16. The non-transitory computer-readable medium of claim 14, wherein the data comprises telematics data transmitted by the peripheral device.

17. The non-transitory computer-readable medium of claim 14, wherein the peripheral device comprises:
a radar system;
a sonar system;
a propulsion system;
a global positioning system (GPS) device;
an auto pilot;
a wind instrument;
a water temperature gauge;
a depth sounder;
an engine instrument; or
a combination thereof.

18. The non-transitory computer-readable medium of claim 14, wherein the peripheral device is a National Marine Electronics Association (NMEA) compliant device.

19. The non-transitory computer-readable medium of claim 14, wherein the computer-executable instructions further cause the computer to transmit data from one or more of the categories to a third party.

20. The non-transitory computer-readable medium of claim 19, wherein the third party comprises:
one or more boat manufacturers;
one or more engine manufacturers;
one or more boating or fishing gear suppliers;
one or more insurance companies;
one or more finance companies;
one or more service or maintenance product providers; or
a combination thereof.
